(19) United States
(12) Patent Application Publication
(10) Pub. No.: US 2007/0036342 A1
(43) Pub. Date: Feb. 15, 2007

(54) Method and system for operation of a voice activity detector

(76) Inventors: Marc A. Boillot, Plantation, FL (US); Jason D. Mclntosh, Weston, FL (US); Mikhail U. Yagunov, Pompano Beach, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/198,080

(22) Filed: Aug. 5, 2005

(51) Int. Cl. H04M 9/08

(52) U.S. Cl. 379/406.01

(57) ABSTRACT

The invention concerns a system (100) and method (400) for operation of a voice activity detector (230). The system can include a speaker (105), a first microphone (110) and a second microphone (120) in which the first microphone and the second microphone can capture acoustic output from the speaker. The system can also include an adaptive module (220) in which the first microphone and the second microphone can provide signals to the adaptive module, and the adaptive module can provide an input to the voice activity detector. The adaptive module can receive a first input (242) from the first microphone and a second input (243) from the second microphone and can attempt to determine (430) a transformation between the first and second inputs for setting a configuration of the voice activity detector.

### BACKGROUND OF THE INVENTION

1. Field of the Invention

This invention relates in general to the processing of acoustic signals and more particularly, to processing of acoustic signals in relation to signal suppression and the configuration of components based on the acoustic signals.

2. Description of the Related Art

The use of portable electronic devices has risen in recent years. Cellular telephones, in particular, have become very popular with the public. The primary purpose of cellular phones is for voice communication. A cell phone generally employs voice compression techniques to reduce the amount of bandwidth necessary to send and receive data across a communications channel. Voice activity detectors are routinely employed to determine when voice is present on a communication channel for facilitating voice compression. A voice activity detector determines when voice is present based on the characteristics of the audio signal, such as energy, periodicity, and spectral shape. In addition, a voice activity detector is routinely used to inform a compression routine when voice compression is necessary.

Also, many cell phones are equipped with a high-audio speaker that allows a user to engage in a cell phone conversation with a caller at a handheld distance without having to hold the phone next to the user's ear. This process is commonly referred to as speakerphone mode. Generally, during this speakerphone mode, the volume level of the speaker output is increased and the microphone sensitivity is raised to increase voice loudness of the caller and to amplify the voice of the user. The amplification of the speaker output and increased gain sensitivity of the microphone, however, can cause a feedback condition. In particular, the speaker output containing the caller voice that is played to the user can reverberate in the environment in which the phone resides and may feed back as an echo into the user microphone. The caller may hear this feedback as an echo of his or her voice, which may be annoying. For this reason, echo suppressors are routinely employed to remove the echo from the receiving handset to prevent the caller from hearing his or her own voice at the calling handset.

Echo suppressors, however, cannot completely remove the echo because they have difficulty modeling the acoustic path due to mechanical and environmental non-linearities. Moreover, an echo suppressor can get confused when the user of the receiving unit talks at the same time the caller's voice is being played out the speakerphone. This scenario is commonly referred to as a double talk condition, which produces an acoustic signal that includes the output audio from the speaker and the user's voice, both of which are captured by a microphone of the user's handset. The echo suppressor cannot distinguish between the voice of the caller (output from the speaker) and the user of the receiving unit. Accordingly, the echo suppressor is unable to attenuate the echo due to the additional voice activity of the double talk condition. If a voice activity detector is configured with an echo suppressor and a doubletalk condition occurs, the voice activity detector may not be able to determine whether voice is present, which may cause it to be improperly configured.

### SUMMARY OF THE INVENTION

The present invention concerns a system for operation of a voice activity detector. The system can include a speaker, a first microphone, a second microphone—in which the first microphone and the second microphone can capture acoustic output from the speaker—and an adaptive module. The first microphone and the second microphone can provide signals to the adaptive module, and the adaptive module can provide an input to the voice activity detector. In one arrangement, the adaptive module can receive a first input from the first microphone and a second input from the second microphone and can attempt to determine a transformation between the first and second inputs for setting a configuration of the voice activity detector.

As an example, the first microphone can be located closer to the speaker than the second microphone. As another example, the first microphone and the second microphone can be oriented in the same direction. Also, they can be positioned to maximize the possibility that the first microphone and the second microphone will be located at least substantially equidistant from a user's mouth as the user is speaking into a communication device housing the first and second microphone, although the invention is not so limited.

In another arrangement, the adaptive module can attempt to determine the transformation between the first and second inputs by modeling a direct path frequency response between the first and second microphones. Modeling the direct path frequency response between the first and second microphones can substantially prevent false triggering of the voice activity detector.

In one embodiment of the invention, the system can further include a supplemental suppressing module that can receive signals from the first microphone and the second microphone and can be coupled to the adaptive module. The supplemental suppressing module can suppress an unwanted acoustic signal in the first input to the adaptive module from the first microphone in which at least a portion of the unwanted acoustic signal is received by both the first microphone and the second microphone. In particular, the supplemental suppressing module can suppress the unwanted acoustic signal in the first input to the adaptive module from the first microphone by subtracting the input of the second microphone from the input of the first microphone.

In another arrangement, the adaptive module can produce a convergence error that can measure a contribution to the unwanted acoustic signal. Also, the voice activity detector may have a send line and a receive line. As such, the voice activity detector can compare a convergence error to a calculated threshold to set a configuration of the send line and the receive line.

The present invention also concerns a system for operation of a voice activity detector. The system can include a first microphone, a second microphone—in which the first microphone and the second microphone capture acoustic output—and a suppressing module that can receive signals from the first microphone and the second microphone. The system can further include an adaptive module in which the suppressing module can provide signals to the adaptive module, and the adaptive module can provide an input to the voice activity detector. In one arrangement, the suppressing module can suppress an unwanted acoustic signal in a first input to the adaptive module from the first microphone to produce a convergence error that the voice activity detector can monitor to determine whether to pass audio signals to a caller.

The system can further include a speaker in which the voice activity detector can monitor the convergence error to determine whether to pass audio signals to the speaker. In another arrangement, the first microphone and the second microphone can be positioned at a distance apart such that the power level difference of the acoustic output received at the first microphone and the acoustic output received at the second microphone is at least 3 dB.

The present invention also concerns a method for operation of a voice activity detector. The method can include the steps of capturing an acoustic output of a speaker at a first microphone for a first input, capturing the acoustic output of the speaker at a second microphone for a second input, attempting to determine a transformation between the first and second inputs and setting a configuration of the voice activity detector based on attempting to determine the transformation. In addition, attempting to determine the transformation between the first and second inputs can include modeling a direct path frequency response between the first and second microphones.

The method can also include the step of suppressing an unwanted acoustic signal in the first input, and at least a portion of the unwanted acoustic signal can be received by both the first microphone and the second microphone. In one arrangement, suppressing the unwanted acoustic signal in the first input can include the step of subtracting the second input of the second microphone from the first input of the first microphone. Also, attempting to determine a transformation between the first and second inputs can include the step of producing a convergence error that can describe a contribution to the unwanted acoustic signal. Setting the configuration of the voice activity detector can include the step of setting a send line and a receive line of the voice activity detector. As such, the method can further include the step of comparing a convergence error to a calculated threshold for setting the send line and the receive line.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a communication device that houses a system for operation of a voice activity detector in accordance with an embodiment of the inventive arrangements;

FIG. 2 illustrates a block diagram of an example of a system for operation of a voice activity detector in accordance with an embodiment of the inventive arrangements;

FIG. 3 illustrates a block diagram of another example of a system for operation of a voice activity detector in accordance with an embodiment of the inventive arrangements;

FIG. 4 illustrates a method for operation of a voice activity detector in accordance with an embodiment of the inventive arrangements; and

FIG. 5 illustrates more steps of the method of FIG. 4 in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The present invention concerns a system for operation of a voice activity detector. In one arrangement, the system can include a speaker, a first microphone, a second microphone—in which the first microphone and the second microphone can capture acoustic output from the speaker—and an adaptive module. The first microphone and the second microphone can provide signals to the adaptive module, and the adaptive module can provide an input to the voice activity detector. In addition, the adaptive module can receive a first input from the first microphone and a second input from the second microphone and can attempt to determine a transformation between the first and second inputs for setting a configuration of the voice activity detector. Having more than one microphone can improve the modeling capabilities of a communication device having the voice activity detector because the actual acoustic output of the speaker is captured.

The present system may also include a supplemental suppressing module that can receive signals from the first microphone and the second microphone and can be coupled to the adaptive module. In one arrangement, the supplemental suppressing module can suppress an unwanted acoustic signal in the first input to the adaptive module from the first microphone in which at least a portion of the unwanted acoustic signal may be received by both the first microphone and the second microphone. As an example, a double-talk signal may be part of the unwanted acoustic signal. This process can help the voice activity detector better control communication lines between the user and caller.

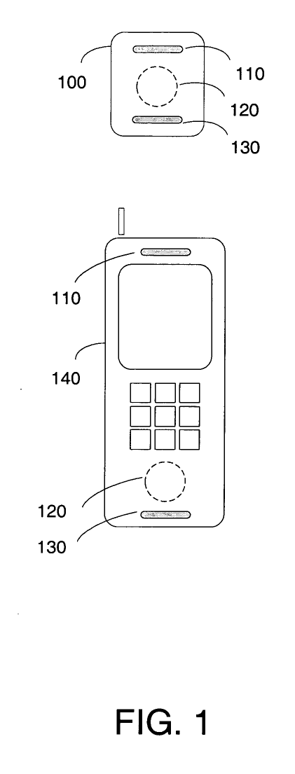

Referring to FIG. 1, a system 100 with a speaker and dual microphone configuration is shown. The system 100 can include a speaker 105, a first microphone 110 and a second microphone 120 to respectively play and capture acoustic audio signals. As an example, the system 100 can be embodied within a communication device 140, such as a cellular telephone, to improve modeling capabilities of the communication device 140 and to facilitate the detection of double-talk conditions. The communication device 140 can enter into a voice communication to transmit and receive audio from a calling source. It is understood that the communication device 140 can communicate with the calling source over a wired or wireless connection.

The communication device 140 can be used in speakerphone mode to play out high level (or even low level) acoustic audio from the speaker 105. This audio may be unintentionally captured by the first and second microphones 110,120. As will be explained below, the system 100 may improve the ability of the communication device 140 to accommodate this effect.

In one arrangement, the first microphone 110 can be placed closer to the speaker 105 than the second microphone 120. In view of this configuration, one can appreciate that the level of the acoustic speaker output captured by the first microphone 110 can be higher than the level of the acoustic speaker output captured by the second microphone 120. Also, the first microphone 110 and the second microphone 120 may be positioned at a distance apart such that the power level difference of the acoustic output received at the first microphone 110 and the acoustic output received at the second microphone 120 can be at least 3 dB.

In another arrangement, the first microphone 110 and the second microphone 120 can be oriented in the same direction, as shown in FIG. 1. The first microphone 110 and the second microphone 120 may also be positioned to maximize the probability that the first microphone 110 and the second microphone 120 are equidistant from a talker's mouth as the talker is speaking into the communication device 140. This may be particularly relevant if the communication device 140 is in a speakerphone mode where the user's mouth is not necessarily positioned next to the communication device 140. It should be noted, however, that the placement and positioning of the dual microphones is not limited to the front side or any other particular location of the communication device 140 or even to the communication device 140 itself.

Briefly, the speaker 105 can output audio to a user of the communication device 140, which may be captured by the first microphone 110 and second microphone 120. The user may speak into the communication device 140 while audio is played out the speaker 105 to create a double-talk condition. In accordance with an embodiment of the inventive arrangements, the system 100 can still detect the presence of the user's voice while audio is concurrently being output from the speaker 105, which can enable proper operation of the communication device 140 during the double-talk condition. As will also be explained below, the system 100 can improve the modeling capabilities of the communication device 140.

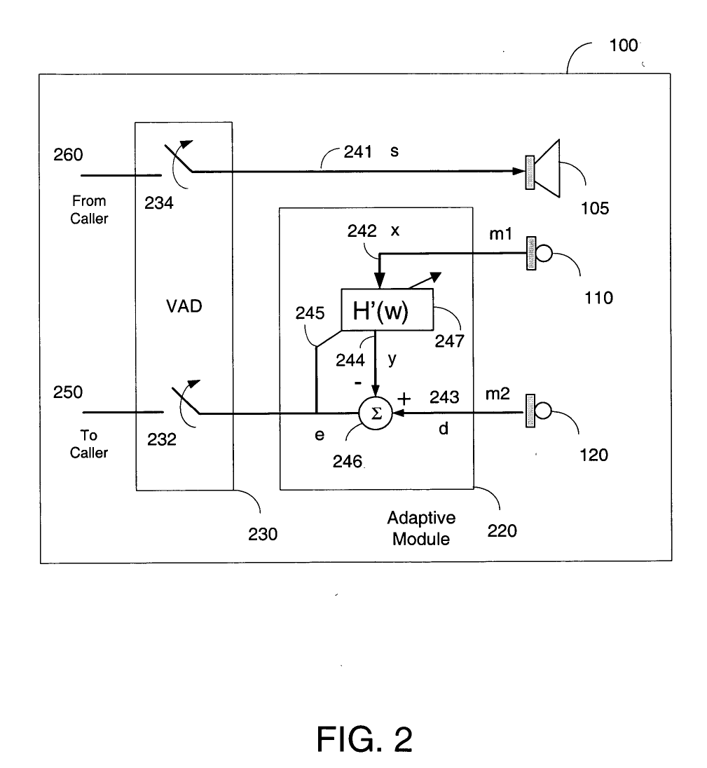

Referring to FIG. 2, a more detailed block diagram of the system 100 is shown. In one arrangement, the system 100 can include the speaker 105 that outputs the audio, the first microphone 110, the second microphone 120, an adaptive module 220, and a voice activity detector (VAD) 230. The first microphone 110 and the second microphone 120 can have inputs to the adaptive module 220, which may be labeled as ml and m2, respectively. Further, the adaptive module 220 can have an input to the VAD 230. In one arrangement, the adaptive module 220 can attempt to determine a transformation between the first input ml and the second input m2 and can suppress the acoustic output of the speaker 105 that may be captured by the second microphone 120. In this example, the acoustic output of the speaker 105 may be referred to as an unwanted acoustic signal.

For example, the adaptive module 220 can attempt to determine a linear transformation between a first input 242 received at the first microphone 110 and a second input 243 received at the second microphone 120. The adaptive module 220 can generate a filter response 247(H(w)) that can represent the linear transformation between the signal on the first input 242 or “x” and the signal on the second input 243 or “d.” The filter response 247 can describe the spectral magnitude differences and phase differences between the two inputs 242, 243. This process can be useful for suppressing a direct path response of the speaker 105 because the direct response is generally a delayed and gain-scaled version of a speaker input 241 or “s.” The adaptive module 220 can process the first input 242 with the filter response 247 to produce a modeled response 244 or “y.” Further, the adaptive module 220 can capture a difference between the modeled response 244 and the second input 243 as an error signal 245 or “e,” which may also be referred to as a convergence error signal or simply, convergence error. The adaptive module 220 can include an adder 246 that can subtract the difference between the modeled response 244 and the second input 243. Additionally, the adaptive module 220 may employ the error signal 245 as feedback to measure the similarity in the resulting transformation between the two inputs 242, 243.

As is known in the art, a small error signal may imply sufficient modeling of the direct path response. In contrast, a large error may imply poor modeling of the direct response, which can be attributed to the two input signals 242, 243 being highly separable. Highly separable can mean that the signals may be uncorrelated or cannot be related by a linear transformation. As such, a highly separable signal can be the result of combining two non-similar audio signals. The adaptive module 220 can produce a small error when the transformation is an accurate model of the direct path. The adaptive module 220, however, may produce a large error when it attempts to model more than the direct path. As a result, it can be said that the adaptive module 220 attempts to determine a transformation between the first input 242 and the second input 243.

As noted earlier, the adaptive module 220 can have an input to the VAD 230. In one arrangement, the input can be the convergence error 245, and the VAD 230 can compare the convergence error 245 with a threshold, which can be stored in the VAD 230 or some other suitable component. Based on this comparison and as will be explained below, the VAD 230 may selectively control the output or input of several audio-based components of the communication device 140. As part of this control, various configurations of the voice activity detector 230 may be set, examples of which will be presented below.

In one arrangement, the VAD 230 may include a switch 232 through which audio signals from the adaptive module 220 pass on their way for further processing for transmission to another communication device. The switch 232 can be on a send line 250 that carries these signals that are meant for another caller, i.e., the person to whom the user of the communication device 140 is speaking. The VAD 230 may include another switch 234 through which audio signals pass on their way to the speaker 105. The switch 234 can be on a receive line 260 that carries the signals that have been received from the caller of the other communication device.

As noted above, the adaptive module 220 can pass the error signal 245 (convergence error) to the VAD 230 as an input. The VAD 230 can evaluate the error signal 245 to enable or disable the send line 250 and the receive line 260 through the switches 232, 234. As an example, the VAD 230 can connect the send line 250 via the switch 232 and can concurrently disconnect the receive line 260 via the switch 234 if the convergence error exceeds a threshold. This scenario may occur if a user is speaking into the communication device 140.

Conversely, the VAD 230 can disconnect the send line 250 via the switch 232 and can concurrently connect the receive line 260 via the switch 234 if the convergence error does not exceed the threshold. This situation may occur when a caller of another communication device is speaking to a user of the communication device 140 and the caller's voice is being played out of the speaker 105. As an example, the operation of the switches 232, 234 may be diametric in nature.

In view of the configuration shown in FIG. 2, a true direct path response can be the acoustic path that couples the output of the speaker 105 to the second microphone 120. The true direct path can be one-way but may not necessarily be an echo or a reflection signal. The dual microphone configuration can increase the modeling accuracy of the adaptive module 220 and can reduce the error in estimating the direct path response. The first microphone 110 can be placed closest to the speaker 105 to capture the truest representation of the acoustic speaker output before it travels along the true direct path.

Prior art systems feed the line signal 241 to the adaptive module 220 (they do not contain a microphone near the output of the speaker 105). In accordance with one embodiment of the inventive arrangements, the first microphone 110 can capture an acoustic signal that can be a truer representation of the output audio of the speaker 105 than the line 241 feeding the speaker 105. The reason for this improvement is because the signal on the speaker input 241 can undergo a non-linear transformation when it is played out the speaker 105, possibly due to mechanical non-linearities of the transducer and housing of the speaker 105.

An adaptive module 220 that uses the line signal 241 in place of the first microphone 110 attempts to estimate the speaker non-linearties during the modeling of the direct path, which increases the error. In addition, other non-linear effects may be present, such as an amplifier powering the speaker 105 going into saturation, which could clip the signal.

The additional burden of estimating the non-linearities of the speaker 105 can be removed by using the first microphone 110 closest to the speaker 105. The first microphone 105 can capture the acoustic output of the speaker 105 after it has undergone non-linear transformations by the speaker 105 and before it undergoes any subsequent transformations due to the environment of the communication device 140. The first microphone 110 and the second microphone 120 together can help model a direct path response occurring between them to estimate the true direct path and reduce the adaptation error. Of course, the invention is not limited to the configuration shown in FIG. 2, as other suitable designs may be employed, including one where the line signal 241 is directly fed into the adaptive module 220.

In another arrangement, the adaptive module 220 can be configured to determine when a signal is on the speaker input 241. In view of this determination, the adaptive module 220 can be prevented from accidentally trying to model the frequency response between the first microphone 110 and the second microphone 120 when only a user is speaking into the communication device 140. As such, the VAD 230 can be prevented from unintentionally disconnecting the send line 250 when such a user is speaking. Those of skill in the art will appreciate that any suitable component or process can be implemented to allow the adaptive module 220 to monitor the speaker input 241. Also, if desired, a switch (not shown) can be implemented in the system 100 that can selectively couple the adaptive module 220 to the first microphone 110 and the speaker input 241

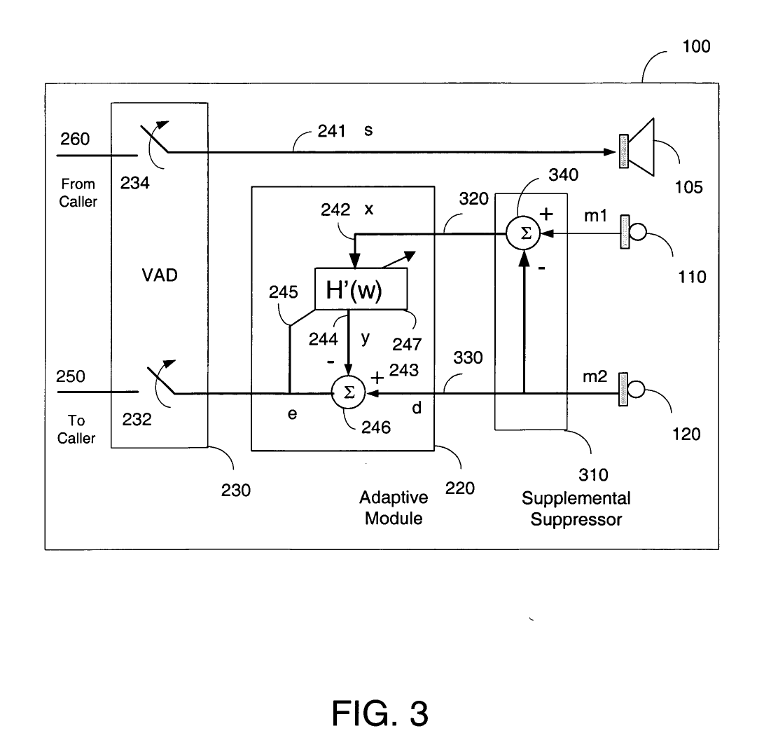

Referring to FIG. 3, a block diagram of the system 100 illustrates the inclusion of a supplemental suppressor 310. The supplemental suppressor 310 can receive signals from the first microphone 110 and second microphone 120 and can be coupled to the adaptive module 220. In one arrangement, the supplemental suppressor 310 can suppress an unwanted acoustic signal in a first input 320 to the adaptive module 220 from the first microphone 110, where at least a portion of the unwanted acoustic signal is received by both the first microphone 110 and the second microphone 120. In this example, the unwanted acoustic signal can be a combination of any signals, including just one signal, that is captured by the second microphone 120. For example, the unwanted audio signal may be a double-talk signal that is captured by the second microphone 120, although the invention is not so limited. The double-talk signal can be an acoustic signal that includes the acoustic output of the speaker 105 and the voice output of a user speaking into the communication device 140. The supplemental suppressor 310 can pass the signal received by the second microphone 120 to a second input 330 of the adaptive module 220 without modification.

In one arrangement, the supplemental suppressing module 310 can include an adder 340. The adder 340 can permit the supplemental suppressing module 310 to suppress the unwanted acoustic signal in the first input 320 to the adaptive module 220 from the first microphone 110 by subtracting the input m2 of the second microphone 120 from the input ml of the first microphone 110. As such, the supplemental suppressor 310 can suppress a common unwanted acoustic signal to improve the separability of the first input 320 and the second input 330 to the adaptive module 220. The unwanted acoustic signal may be common to the first input 320 and the second input 330 in that at least portions of all the components of the unwanted acoustic signal are captured by the first microphone 110 and the second microphone 120. This removal of the unwanted acoustic signal can improve the operation of the VAD 230 by allowing it to properly manage the operation of the switches 232, 234.

In one arrangement and as noted earlier, the first microphone 110 and the second microphone 120 can be positioned to maximize the possibility that the first microphone 110 and the second microphone 120 will be located at least substantially equidistant from a user's mouth as the user is speaking into the communication device 140. As also previously explained, the first microphone 110 can be positioned closer to the speaker 105 than the second microphone 120. It has been shown that this particular configuration achieves optimal results for the operation of the invention shown in FIG. 3. In other words, the communication device 140 may be able to sufficiently suppress the output from the speaker 105 and to properly configure its settings. Of course, the invention is not limited to this particular embodiment, as those of skill in the art will appreciate that the first microphone 110 and the second microphone 120 may be positioned at any other suitable locations, depending on the type of performance that is desired.

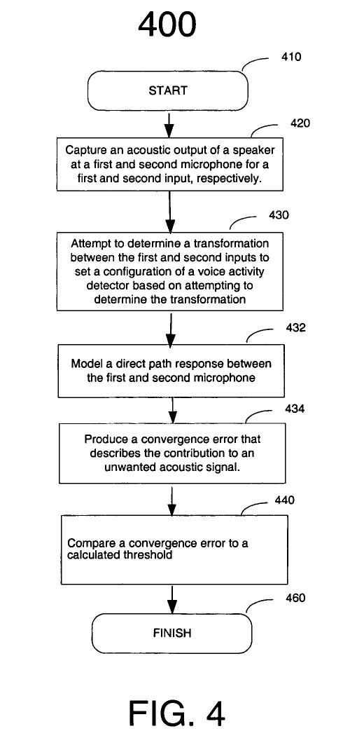

Referring to FIG. 4, a method 400 for improved operation of a voice activity detector is shown. When describing the method 400, reference will be made to FIG. 2, although it must be noted that the method 400 can be practiced in any other suitable system or device. Moreover, the steps of the method 400 are not limited to the particular order in which they are presented in FIG. 4. The inventive method can also have a greater number of steps or a fewer number of steps than those shown in FIG. 4. In one particular example, the communication device 140 that will be described in reference to this example can have a high-audio speaker, although the invention is in no way limited to such an arrangement.

At step 410, the method 400 can start. At step 420, an acoustic output of a speaker can be captured by a first microphone and a second microphone for first and second inputs, respectively. At step 430, an attempt to determine a transformation between the first and second inputs can be performed, which can help set a configuration of the voice activity detector. For example, a direct path response between the first and second microphone can be modeled, as shown at step 432. In addition, at step 434, a convergence error can be produced that can describe the contribution to an unwanted acoustic signal. The convergence error can be compared to a calculated threshold to determine whether the unwanted acoustic signal is present, as shown at step 440. The method 400 can then end at step 460.

For example, referring to FIG. 2, the first microphone 110 and the second microphone 120 can capture a direct path acoustic signal emitted from the speaker 105, which may be a high-audio output. For purposes of the invention, a high-audio output can be any audio output that is broadcast from a speaker that is designed to permit a user to listen to the speaker without his or her ear pressed against the body of the device housing the speaker. An example of such a configuration is a speakerphone feature in a wireless or wired telephone.

The adaptive module 220 can receive as a first input the signal from the first microphone 110 and as a second input the signal from the second microphone signal 120. In turn, the adaptive module 220 can estimate a linear transformation between the first input 242 x and the second input 243 d as the filter response H(w) 247. The adaptive module 220 can then update the filter response for each new audio sample received at the first input 242 and the second input 243. The adaptive module 220 may also convolve the frequency response H(w) 247 with the first input 242 x to produce the modeled response 244 y. This modeled response can be a modeled direct path response between the first microphone 110 and the second microphone 120.

As noted earlier, the adaptive module 220 can include an adder 246 that can subtract the modeled response 244 y from the second input 243. As such, the adder 246 can produce a convergence error 245, which may describe the contribution to an unwanted acoustic signal. As an example and in this case, the unwanted acoustic signal may be the acoustic output of the speaker 105 that is captured by the first microphone 110 and the second microphone 120. The convergence error 245 can be fed back within the adaptive unit 220 to compare the estimated frequency response 247 with the direct path to evaluate the likeliness or similarity between the two. An increased similarity means that the adaptive module 220 is capable of accurately modeling the direct path.

Briefly, the modeled response y may account for a gain and time scaling effect of the direct response. The adaptive module 220 can suppress the acoustic output received from the second microphone 120 by subtracting the modeled response 244 y. Also, the adaptive module 220 can pass the error signal 245 e to the VAD 230 as an input. As explained previously, the VAD 230 can evaluate the error signal 245 e and can set a configuration of the VAD 230. For example, the VAD 230 can determine whether to enable or disable the send line 250 and the receive line 260, respectively through switches 232, 234.

In particular, the VAD 230 can compare the convergence error 245 to a calculated threshold to determine whether the unwanted acoustic signal is present. If the convergence error 245 is below the calculated threshold, then the VAD 230 detects the unwanted acoustic signal and can disconnect the send line 250 and connect the receive line 260. The calculated threshold can be dynamic in that it can be continuously updated to improve the performance of the VAD 230, although the invention is not limited in this regard.

As those of skill in the art will appreciate, the adaptive module 220 can attempt to suppress the acoustic output of the speaker 105 from the second microphone 120. The adaptive module 220, however, may not be able to completely suppress this output. Nevertheless, the VAD 230 can completely suppress the output of the adaptive module 220 by disconnecting the send line 250 to the caller so that the caller would not hear his or her voice emanating from the speaker 105.

For example, consider the situation where a caller has called the communication device 140 and the caller's voice is the only audio playing out the speaker 105. In this example, the caller's voice from the speaker 105 can be considered the unwanted signal when it is captured by the first microphone 110 and the second microphone 120. The adaptive module 220 can be capable of suppressing the unwanted signal because the VAD 230 can keep the switch 232 disconnected and the switch 234 connected, which allows the caller's voice to play out the speaker 105 over the receive line 260. In this configuration the VAD 230 is ensuring that no unwanted signal is being played back to the caller (through the first microphone 110 and the second microphone 120) and that the caller will not hear his or her voice.

When the unwanted signal is solely the output of the speaker 105, the adaptive module 220 is capable of modeling the direct path response, and the convergence error 245 will be low. The VAD 230 can measure the contribution to the unwanted acoustic signal in view of the convergence error 245. Given a low error signal, the VAD 230 can keep the switch 232 disconnected.

Modeling the direct path frequency response, as described above, can also substantially prevent false triggering of the VAD 230. For example, consider the scenario where the acoustic signal from the speaker 105 is being clipped. Because the clipped signal is being captured by both the first microphone 110 and the second microphone 120, the adaptive module 220 can produce a low convergence error 245, which can enable the VAD 230 to determine to keep the switch 232 disconnected. If the adaptive module 220 was receiving input from the speaker line 241 and not the actual acoustic output (i.e., clipped signal) of the speaker 105, then the convergence error 245 may be high. This event may cause a false triggering of the VAD 230, which may cause the switch 232 to be unintentionally closed and lead to the output of the speaker 105 being transmitted to the person calling the communication device 140.

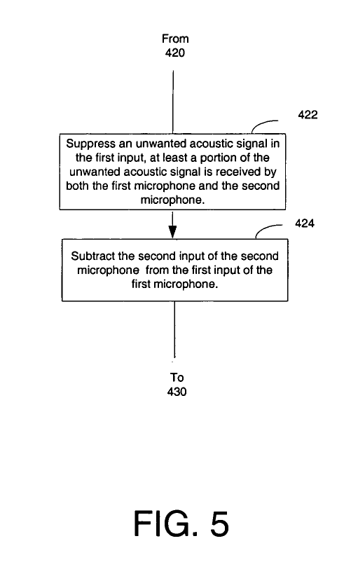

Referring to FIG. 5, a method 500 that incorporates the steps of the method 400 is shown. The method 500 may be useful for detecting double-talk signals, which may form part of an unwanted acoustic signal. Again, when describing the method 500, reference will be made to FIG. 3, although it must be noted that the method 500 can be practiced in any other suitable system or device. Moreover, the steps of the method 500 are not limited to the particular order in which they are presented in FIG. 5. The inventive method can also have a greater number of steps or a fewer number of steps than those shown in FIG. 5, which includes not having all the steps of the method 400 of FIG. 4, if so desired.

With reference to FIG. 4, the conditioning steps can occur between the method steps 420 and 430, although the invention is not so limited to this particular order. At step 422, an unwanted acoustic signal in a first input can be suppressed, where the unwanted acoustic signal is received by both a first microphone and a second microphone. At step 424, the second input of the second microphone can be subtracted from the first input of the first microphone to accomplish the suppressing action of step 422.

For example, referring to FIG. 3 and as noted above, a double-talk condition may involve a situation where the speaker 105 is outputting audio and a user of the communication device 140 begins to speak into the communication device 140. Thus, a double-talk signal may include signals from the speaker 105 and the voice of the user using the communication device 140, and the combination of these signals, as picked up by the second microphone 120, can be the unwanted acoustic signal. This unwanted acoustic signal can be captured by both the first microphone 110 and the second microphone 120.

The supplemental suppressor 310 can suppress the unwanted acoustic signal in the first input 320 to the adaptive module 220 from the first microphone 110. As explained above, the supplemental suppressor 310 can include an adder 340, which can subtract the acoustic signal received by the second microphone 120 from the acoustic signal received by the first microphone 110. The output of the adder 340 can be fed to the first input 320 of the adaptive module 220. In one arrangement, the supplemental suppressor 310 can suppress the unwanted acoustic signal to increase the convergence error 245 of the adaptive module 220. As such, the supplemental suppressor 310 can suppress a common unwanted acoustic signal to increase the separability between the first input 320 and the second input 330.

By removing the common unwanted acoustic signal from the first input 320 and leaving the common unwanted acoustic signal on the second input 330, the adaptive module 220 can generate a higher convergence error 245 due to the discrepancies between the two signals captured by the first microphone 110 and the second microphone 120. Accordingly, the adaptive module 220 cannot accurately estimate a direct path response because the unwanted signal produces a non-linear relationship between the first input 320 and the second input 330. In view of the higher convergence error 245, the VAD 230 can determine to close the switch 232 to permit the voice signal from the talker to pass on the send line 250. At the same time, the adaptive module 220 is able to suppress the output from the speaker 105.

For example, as explained above, the first microphone 110 and the second microphone 120 can be positioned to maximize the possibility that they will be substantially equidistant to a user's mouth when the user is speaking into the communication device 140. As such, the user's voice may arrive at the first microphone 110 and the second microphone 120 at the same time and at the same level. Also, the first microphone 110 can be placed closer to the speaker 105 than the second microphone 120 such that the speaker output is higher (e.g., 3 dB) at the first microphone 110.

Hence, the subtraction operation of the adder 340 can subtract out the user's voice, which may be at an equal level in both microphones 110,120 but does not completely subtract out the output of the speaker 105 because of the level differences between the microphones 110,120. Accordingly, the supplemental suppressor 310 can provide an isolated speaker 105 output signal as the first input 320 to the adaptive module 220 and a combined signal of the output of the speaker 105 with the user's voice as the second input 330. The adaptive module 220 can attempt to model a linear transformation between the two signals and can generate an increased error convergence 245, as the addition of the user's voice constitutes a non-linear operation.

There may be instances where the user, when speaking into the communication device 140, positions his mouth such that the first microphone 110 and the second microphone 120 are not equidistant from the user's mouth. In this case, the adaptive module 220 may inadvertently produce a low convergence error 245, which may cause the VAD 230 to open the switch 232. To prevent this process from occurring, the adaptive module 220 can monitor the speaker line 241, similar to what was described above with respect to FIG. 2.

Where applicable, the present invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present invention may also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A system for operation of a voice activity detector, comprising:
a speaker;
a first microphone;
a second microphone, wherein the first microphone and the second microphone capture acoustic output from the speaker; and
an adaptive module, wherein the first microphone and the second microphone provide signals to the adaptive module and wherein the adaptive module provides an input to the voice activity detector;
wherein the adaptive module receives a first input from the first microphone and a second input from the second microphone and attempts to determine a transformation between the first and second inputs for setting a configuration of the voice activity detector.

2. The system according to claim 1, wherein the first microphone is located closer to the speaker than the second microphone.

3. The system according to claim 1, wherein the first microphone and the second microphone are oriented in the same direction and positioned to maximize the possibility that the first microphone and the second microphone will be located at least substantially equidistant from a user's mouth as the user is speaking into a communication device housing the first and second microphone.

4. The system according to claim 1, wherein the adaptive module attempts to determine the transformation between the first and second inputs by modeling a direct path frequency response between the first and second microphones.

5. The system according to claim 4, wherein modeling the direct path frequency response between the first and second microphones substantially prevents false triggering of the voice activity detector.

6. The system according to claim 1, further comprising a supplemental suppressing module that receives signals from the first microphone and the second microphone and is coupled to the adaptive module, wherein the supplemental suppressing module suppresses an unwanted acoustic signal in the first input to the adaptive module from the first microphone and wherein at least a portion of the unwanted acoustic signal is received by both the first microphone and the second microphone.

7. The system according to claim 6, wherein the supplemental suppressing module suppresses the unwanted acoustic signal in the first input to the adaptive module from the first microphone by subtracting the input of the second microphone from the input of the first microphone.

8. The system according to claim 6, wherein the adaptive module produces a convergence error that measures a contribution to the unwanted acoustic signal.

9. The system according to claim 6, wherein the voice activity detector has a send line and a receive line and wherein the voice activity detector compares a convergence error to a calculated threshold to set a configuration of the send line and the receive line.

10. A system for operation of a voice activity detector, comprising:
a first microphone;
a second microphone, wherein the first microphone and the second microphone capture acoustic output;
a suppressing module that receives signals from the first microphone and the second microphone; and
an adaptive module, wherein the suppressing module provides signals to the adaptive module and wherein the adaptive module provides an input to the voice activity detector;
wherein the suppressing module suppresses an unwanted acoustic signal in a first input to the adaptive module from the first microphone to produce a convergence error that the voice activity detector monitors to determine whether to pass audio signals to a caller.

11. The system according to claim 10, further comprising a speaker, wherein the voice activity detector monitors the convergence error to determine whether to pass audio signals to the speaker.

12. The system according to claim 10, wherein the first microphone and the second microphone are positioned to maximize the possibility that the first microphone and the second microphone will be located at least substantially equidistant from a user's mouth as the user is speaking into a communication device housing the first and second microphone.

13. The system according to claim 10, wherein the first microphone and the second microphone are positioned at a distance apart such that the power level difference of the acoustic output received at the first microphone and the acoustic output received at the second microphone is at least 3 dB.

14. A method for operation of a voice activity detector, comprising:
capturing an acoustic output of a speaker at a first microphone for a first input;
capturing the acoustic output of the speaker at a second microphone for a second input;
attempting to determine a transformation between the first and second inputs; and
setting a configuration of the voice activity detector based on attempting to determine the transformation.

15. The method according to claim 14, wherein attempting to determine the transformation between the first and second inputs comprises modeling a direct path frequency response between the first and second microphones.

16. The method according to claim 14, further comprising suppressing an unwanted acoustic signal in the first input, at least a portion of the unwanted acoustic signal received by both the first microphone and the second microphone.

17. The method according to claim 16, wherein suppressing the unwanted acoustic signal in the first input comprises subtracting the second input of the second microphone from the first input of the first microphone.

18. The method according to claim 16, wherein attempting to determine a transformation between the first and second inputs comprises producing a convergence error that describes a contribution to the unwanted acoustic signal.

19. The method according to claim 14, wherein setting the configuration of the voice activity detector comprises setting a send line and a receive line of the voice activity detector and the method further comprises comparing a convergence error to a calculated threshold for setting the send line and the receive line.
